(19) United States
(12) Patent Application Publication
(10) Pub. No.: US 2024/0326692 A1
(43) Pub. Date: Oct. 3, 2024

(54) REAR-VIEW ASSEMBLY FOR VEHICLES

(71) Applicant: MOTHERSON INNOVATIONS COMPANY LIMITED, London (GB)

(72) Inventors: David REN, Marysville, MI (US); Randy HARWOOD, Marysville, MI (US)

(21) Appl. No.: 18/443,470

(22) Filed: Feb. 16, 2024

(30) Foreign Application Priority Data
Mar. 31, 2023 (DE) 10 2023 108 330.9

(51) Int. Cl. B60R 1/06

(52) U.S. Cl. CPC B60R 1/06

(57) ABSTRACT

Embodiments of the present disclosure relate to an exterior rear-view mirror assembly that reduces the additional latching requirements, complexity of the assembly process and time. Embodiments of the present exterior rear-view mirror assembly allow multi-stage fixation of the mirror case frame and the mirror housing, including a first twist-lock mechanism that safely holds and locks the mirror case frame with the mirror housing at one end while the other end is reduced to a close proximity between the mirror case frame and the mirror housing, and is latched using a fastening mechanism such that the twist-lock mechanism can only be unlocked when un-fastened from the other end.

### CROSS-REFERENCE TO RELATED APPLICATION

This application claims priority to German Patent Application No. DE 10 2023 108 330.9, filed on Mar. 31, 2023, the entirety of which is incorporated herein by reference for all purposes.

### FIELD

The present invention relates to an external rear-view mirror assembly. In particular, the present invention relates to an external rear-view mirror assembly comprising components that are attached securely. The components are positioned to correctly fit together using special and adapted retention latches. More particularly, the invention is related to assembly of the components with reduced latching components yet resulting in a secured fit. The present invention further relates to a vehicle comprising the exterior rear-view assembly and to a method of assembling the exterior rear-view mirror assembly.

### BACKGROUND

Generally, motor vehicles have a pair of external rear vision mirrors placed at either side of the vehicle such that to obtain a clear sight of the rear end of the vehicle. The mirrors are typically an assembly of a combination of mechanical or electro-mechanical components. Typically, the assembly is inclusive of a mirror head that is designed to rotate, in either forward or rearward directions, about a substantially vertical pivot axis. The mirror head is the component which is adjusted with respect to the driving position such that a rear-view of the vehicle is obtained, either manually or through electric actuation.

Thus, rear view devices are widely known from the prior art, in particular in the form of rear-view mirrors. They generally comprise of a base, which is affixed to a vehicle, and a head which carries at least a mirror glass and/or a camera and often additional elements such as side turn indicators or the like. The head is usually mounted to be pivotally movable with respect to the base. This allows the head to move out of the way in case of a minor collision, thereby preventing damage to the mirror head or injury to pedestrians who get hit by the rear-view device. Furthermore, the head can be pivoted, either manually or sometimes by means of an electric folding system, from an operating position, in which the rear-view device enables the driver of the vehicle to receive a view in particular to the back, to a parking position, in which the head is folded against the side of the vehicle. This reduces the lateral extent of the vehicle with the mirror in the parking position and helps prevent accidental damage to the mirror of a parked vehicle.

The external rear-view mirror assemblies are ubiquitous for contemporary motor vehicles and have long been used to aid the driver in operating the vehicle, especially in improving the rearward view of the driver. Selected components of the mirror assemblies must be connected during the assembly process. For example, a mirror case frame is used to hold the actuator and also support a glass actuator onto which the mirror is mounted. The mirror case frame is also secured to the mirror housing to form the mirror head.

To attach the mirror case frame and the mirror housing, multiple screwing bosses at both the mirror case frame and the mirror housing are needed, and this also demands an increase of fastening means including but not limited to screws and/or bolts. To allow screwing, there arises a need of having multiple screwing holes and thus tooling is required at both the mirror case frame and the mirror housing, consequently increasing the cost of the assembly. Further, a greater number of such screw joints not only increases the assembly process but also increases the possibilities of vibration and regular maintenance.

At times, the correct number of fasteners/screws may not be installed. Also, the fasteners may not be tightened to the proper torque, thereby loosening over time so that the mirror assembly no longer operates satisfactorily. The failure to install the correct number of fasteners or to tighten the fasteners to the proper torque requires a costly replacement of the affected parts and can contribute to a reduction in vehicle safety due to operational failure of the mirror assembly.

In EP2253510 B1 an arrangement for arranging hub cap on the shield of car is disclosed that has clamping units arranged such that deactivation of fixation of cap on shield is controlled by manual displacement without tool. At least two latching lugs in the form of a hook designed to engage and slide within the guide slots. However, a multi-state combinational latching mechanism with reduced latching points is not disclosed in this prior art.

In EP2253510 B1 a rear-view mirror assembly with a least two parts out of the group of part as mirror frame, mirror base, mirror housing is disclosed. It comprises a retention latch which has a circular hood and a rectangular arm formed in a first part and to be inserted into an opening. The frame has an opening and a slot to receive the retention latch hood. However, a multi-state combinational latching mechanism with reduced latching points is not disclosed in this prior art.

In view of the drawbacks of the prior art it is an example objective of the present disclosure to provide an easy connection that can replace several separate connecting means in the prior art and to ease assembly of a rear-view mirror. An advantage of the coupling between parts of the rear-view assembly uses a multi-stage latching mechanism with reduced latching parts while maintain a safe fixation.

Another example advantage of the solution is the cost saving aspect. A multi-stage latching mechanism allows the reduction of tooling thereby costs of production is reduced while maintaining a lower assembly time. Savings on fasteners is also realized.

Yet another example advantage of the present disclosure is the use of the inventive multi-stage latch mechanism for all components of a rear-view mirror. To achieve a reliable and strong connection, the invention is adapted to a range of material and the spring coefficient of the materials.

### SUMMARY

An exterior rear-view mirror assembly for a vehicle according to an embodiment of the present disclosure includes a mirror base attached to a motor vehicle, a mirror head pivotably attached to the mirror base, wherein the mirror head is configured to operate in a plurality of positions with respect to the mirror base. The mirror head includes a mirror case frame operably coupled to a glass actuator for mounting a mirror and an upper mirror housing for securing the mirror case frame and the mirror. The mirror case frame has a first mirror case frame end and a second mirror case frame end, the upper mirror housing has a first upper mirror housing end and a second upper mirror housing end, and the mirror case fame is secured with the upper mirror housing using a twist-lock mechanism in combination with a fastening mechanism. The second mirror case frame and the second upper mirror housing end are coupled using the twist lock mechanism while the first mirror case frame and the first upper mirror housing end are coupled using the fastening mechanism. The twist lock mechanism enables and facilitates the fastening mechanism.

A technical advantage provided by embodiments of the present disclosure may include multi-stage fixation of the mirror case frame and the mirror housing, including a first twist-lock mechanism that safely holds and locks the mirror case frame with the mirror housing at one end while the other end is reduced to a close proximity between the mirror case frame and the mirror housing and is latched using a fastening mechanism such that the twist-lock mechanism can only be unlocked when un-fastened from the other end.

In one further embodiment the exterior rear-view mirror assembly further comprises a lower mirror housing that may be coupled to form a mirror housing to accommodate the mirror case frame and the glass actuator, and the mirror.

Further, in one embodiment a bezel may be secured with the mirror housing wherein the bezel is placed between the glass actuator and the mirror glass.

Further, in one embodiment the mirror case frame may be operably coupled with the glass actuator to enable movement of the mirror glass.

Furthermore, in one embodiment the mirror case frame may be configured with the glass actuator to secure the mirror and at least one actuator for changing the position of the mirror head with respect to the mirror base to one of the plurality of positions.

Furthermore, in one embodiment the mirror may be operably secured with the mirror case frame via the glass actuator such that a pre-configured angle of the mirror glass can be changed with respect to the mirror case frame.

Furthermore, in one embodiment the second mirror case frame end may be configured to accommodate the actuator in a direction perpendicular to an axis X-X extending from the first upper mirror housing end to the second upper mirror housing end of the mirror case frame.

Furthermore, in one embodiment the second mirror case frame end of the mirror case frame may be configured with a mirror case frame profile, having at least one extended rib and at least one end-stop wall, offset to each other.

Furthermore, in one embodiment the at least one end-stop wall may restrict further movement of the mirror case frame in the upward direction.

Furthermore, in one embodiment the second mirror case frame end of the mirror case frame may be configured with a mirror case frame profile, having at least one extended rib.

Furthermore, in one embodiment the second upper mirror housing end may be configured with an opening towards a bottom end of the upper mirror housing.

Furthermore, in one embodiment the opening may be configured to match the mirror case frame profile.

Furthermore, in one embodiment the opening may be further configured with at least one cut-out, and the opening may be configured to allow the mirror case frame to enter, vertically with respect to the length of the upper mirror housing, from the bottom in an upward direction such that at least one rib of the mirror case frame passes through the at least one cut-out of the upper mirror housing.

Furthermore, in one embodiment the twist-lock mechanism may involve twisting the mirror case frame with respect to the upper mirror housing.

Furthermore, in one embodiment the twist-lock mechanism may involve sliding the at least one extended rib of the mirror case frame on a sliding plane of the end-stop wall of the second upper mirror housing such that to restrict a downward movement.

Furthermore, in one embodiment the restriction of movement of the mirror case frame in the upward direction and in the downward direction may be simultaneously achieved by the offset positioning of the at least one end-stop wall and the at least one rib.

Furthermore, in one embodiment the first mirror case frame may be configured with at least one extended arm.

Furthermore, in one embodiment the upper mirror housing may be configured with at least one fastening coupler.

Furthermore, in one embodiment the at least one extended arm is in proximity with the at least one fastening coupler after the twist-lock mechanism is performed between the mirror case frame and the upper mirror housing.

Furthermore, in one embodiment the at least one extended arm and the at least one fastening coupler may be secured using at least one fastening mechanism including a screwing mechanism, a snap-fit mechanism or using adhesive.

In one example aspect, an embodiment of the present disclosure is directed to a vehicle comprising the exterior rear-view assembly according to the invention.

In another example aspect, an embodiment of the present disclosure further provides a method of assembling the exterior rear-view mirror assembly for a motor vehicle, comprising steps of: attaching a mirror base to the vehicle; pivotably attaching a mirror head to the mirror base, wherein the mirror head is configured to operate in a plurality of positions with respect to the mirror base, the mirror head comprises a mirror case frame for mounting a mirror and an upper mirror housing for securing the mirror case frame and the mirror glass; characterized in that securing the mirror case fame with the upper mirror housing using a twist-lock mechanism in combination with a fastening mechanism, coupling the second mirror case frame and the second upper mirror housing end using the twist-lock mechanism, and coupling the first mirror case frame and the first upper mirror housing end using a fastening mechanism, wherein the twist-lock mechanism enables the fastening mechanism, the upper mirror housing has a first upper mirror housing end and a second upper mirror housing end, and the mirror case frame has a first mirror case frame end and a second mirror case frame end.

The embodiment encompasses performing the twist-lock function between the mirror case frame and the upper mirror housing.

Further, in one embodiment the method may further comprise engaging the mirror case frame towards the opening of the upper mirror housing, vertically with respect to the length of the upper mirror housing, from the bottom in an upward direction such that at least one rib of the mirror case frame passes through the at least one cut-out of the upper mirror housing.

Furthermore, in one embodiment the method may further comprise twisting the mirror case frame with respect to the upper mirror housing to perform the twist-lock mechanism.

Furthermore, in one embodiment the method may further comprise securing the at least one extended arm and the at least one fastening coupler using at least one fastening mechanism including a screwing mechanism, a snap-fit mechanism or using adhesive, and performing the fastening mechanism in an event the twist-lock mechanism brings the at least one extended arm and the at least one fastening coupler in proximity.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The invention itself, together with further features and attended advantages, will become apparent from consideration of the following detailed description, taken in conjunction with the accompanying drawings. One or more embodiments of the present invention are now described, by way of example only wherein like reference numerals represent like elements and in which:

FIG. 1 illustrates an isometric view of an exterior rear-view mirror assembly adapted to be used with a vehicle, according to an embodiment of the present disclosure;

FIG. 2 illustrates an exploded view of a mirror head of the exterior rear-view mirror assembly, according to an embodiment of the present disclosure;

FIG. 3 illustrates an isometric view of an upper mirror housing of the exterior rear-view mirror assembly, according to an embodiment of the present disclosure;

FIGS. 4a-4c illustrate isometric views of a mirror case frame of the exterior rear-view mirror assembly, according to an embodiment of the present disclosure;

FIG. 5 illustrates an isometric view of an assembly of the upper mirror housing and of the mirror case frame, according to an embodiment of the present disclosure;

FIGS. 6a-6b illustrate isometric views of the assembly of the upper mirror housing and of the mirror case frame in an unlocked state, according to an embodiment of the present disclosure; and

FIGS. 7a-7b illustrate isometric views of the assembly of the upper mirror housing and of the mirror case frame in a locked state, according to an embodiment of the present disclosure.

### DETAILED DESCRIPTION

The drawings referred to in this description are not to be understood as being drawn to scale except if specifically noted, and such drawings are only exemplary in nature.

The term “comprises”, “comprising”, “including”, “having”, “consist of” or any other variations indicate non-exclusive inclusion in order to cover a setup, structure or method that comprises a list of components or steps does not include only those components or steps but may include other components or steps not expressly listed or inherent to such setup or structure or method. Meaning thereby, one or more elements in an apparatus proceeded by “comprises . . . a” does not, without more constraints, preclude the existence of other elements or additional elements in the system or apparatus.

For increasing the intelligibility of this invention, references are made to the embodiment illustrated in the accompanying Figures and description herein below, further, in the following Figures, the same reference numerals are used to identify the same components in alternative views.

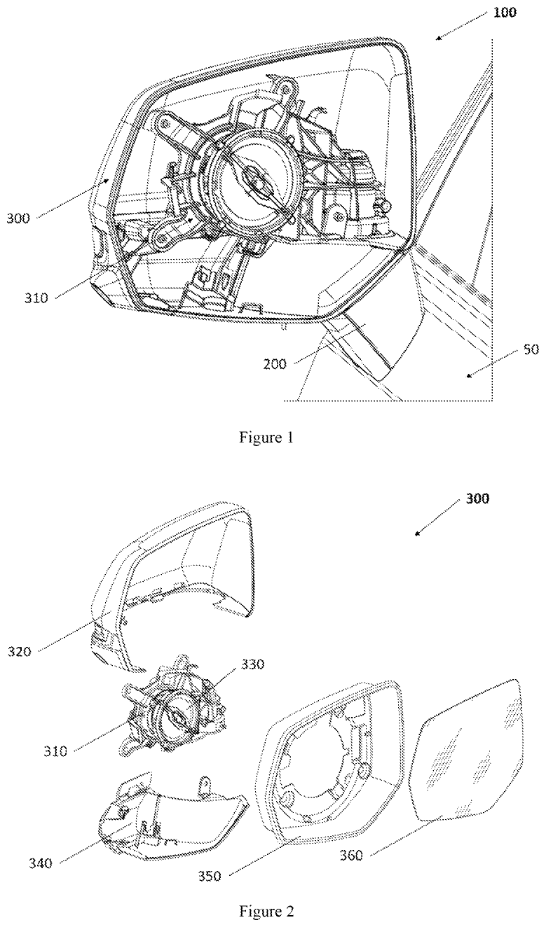

FIG. 1 illustrates an isometric view of an exterior rear-view mirror assembly 100 adapted to be used with a vehicle 50. The exterior rear-view mirror assembly 100 comprises: mirror base 200, a mirror head 300, mirror case frame 310. As illustrated in FIG. 2, with an exploded view, the exterior rear-view mirror assembly 100 further comprises a glass actuator 330 and a mirror glass 360. The mirror base 200 attached to the vehicle 50 with a secured fit. The mirror head 300 is pivotably attached to the mirror base 200 to have a freedom of rotation either in clock-wise or anti-clockwise direction. The mirror head 300 is configured to operate in a plurality of positions with respect to the mirror base 200. The mirror head 300 comprises the mirror case frame 310 and an upper mirror housing 320, wherein the mirror case frame 310 is configured to operably secure the mirror glass 360 via the glass actuator 330, and the upper mirror housing 320 for partially covering the mirror case frame 310 and the mirror glass 360.

The term “rear-view” is here defined as a view of the surrounding area, which is not in the (direct) field of view of a driver, i.e. the directions opposing, left, right, below and above of the viewing direction, but can also comprise the view in the direction of the viewing direction of the driver and/or any combinations of the directions.

Further, as illustrated in FIG. 2, the mirror head 300 comprises a bezel 350 and a lower mirror housing 340. The bezel 350 is placed between the glass actuator 330 and the mirror glass 360. The bezel 350 is further secured with the assembly of the upper and lower mirror housings 320, 340.

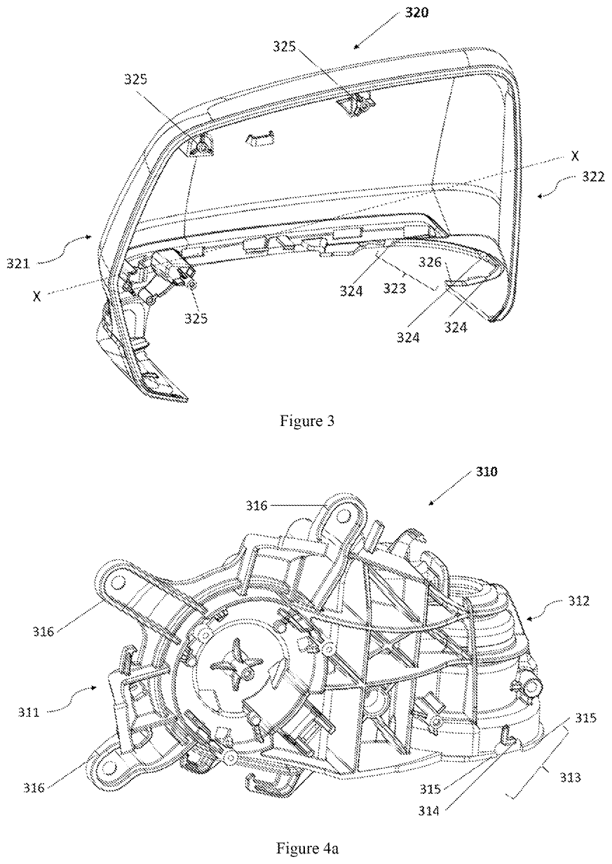

FIG. 3 illustrates an isometric view of the upper mirror housing 320 of the exterior rear-view mirror assembly. The upper mirror housing has a first upper mirror housing end 321 and a second upper mirror housing end 322. The the second upper mirror housing end 322 of the upper mirror housing 320 is configured with an opening 323 towards a bottom end of the upper mirror housing 320. The opening 323 is further configured with at least one cut-out 324.

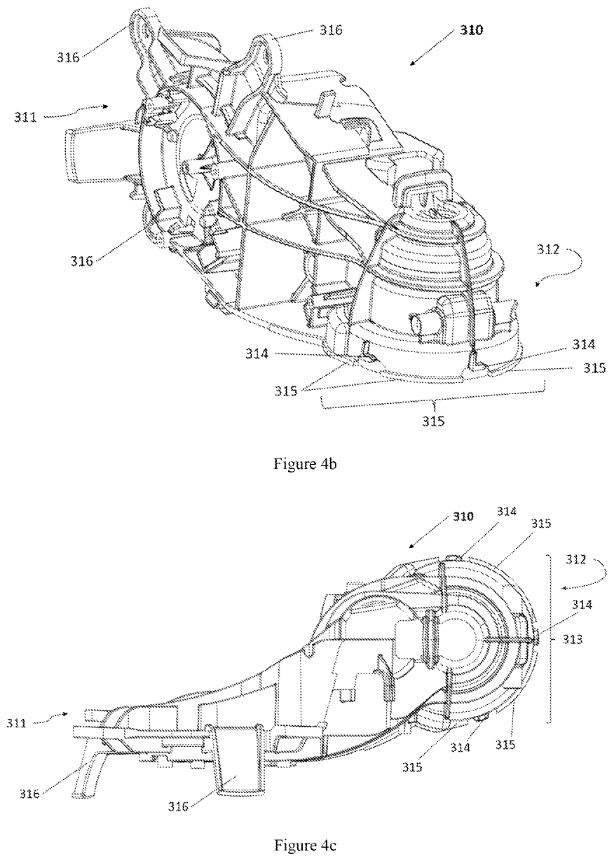

The opening 323 is configured to allow the mirror case frame 310 to enter, vertically with respect to the length of the upper mirror housing 320 along the axis X-X, from the bottom in an upward direction such that at least one rib 314, as illustrated in FIG. 4a-4c, of the mirror case frame 310 passes through the at least one cut-out 324 of the upper mirror housing 320. The twist-lock mechanism involves twisting the mirror case frame 310 with respect to the upper mirror housing 320. The upper mirror housing 320 is further configured with at least one fastening coupler 325 including but not limited to screw slots or snap-fit coupler.

FIGS. 4a-4c illustrate isometric views of the mirror case 310 frame of the exterior rear-view mirror assembly 100. The mirror case frame 310 has a first mirror case frame end 311 and a second mirror case frame end 312. The mirror case frame 310 is operably coupled with the glass actuator 330 to enable movement of the mirror glass 360, which can be done manually or motorized. The mirror glass 360 is operably secured with the mirror case frame 310 via the glass actuator 330 such that a pre-configured angle of the mirror glass 360 can be changed with respect to the mirror case frame 310.

The mirror case frame 310 is also configured to accommodate at least one actuator (now shown) for changing the position of the mirror head 300 with respect to the mirror base 200 to one of a plurality of positions, ideally a driving position, a folding position and a backward position. The second mirror case frame end 312 is configured to accommodate the actuator (now shown) in a direction perpendicular to an axis X-X extending from the first upper mirror housing end 311 to the second upper mirror housing end 312 of the mirror case frame 310. The second mirror case frame end 312 of the mirror case frame 310 is configured with a mirror case frame profile 313, having at least one extended rib 314 and at least one end-stop wall 315, offset to each other. The at least one end-stop wall 315 restricts further movement of the mirror case frame 310 in the upward direction. The first mirror case frame end 311 is configured with at least one extended arm 316.

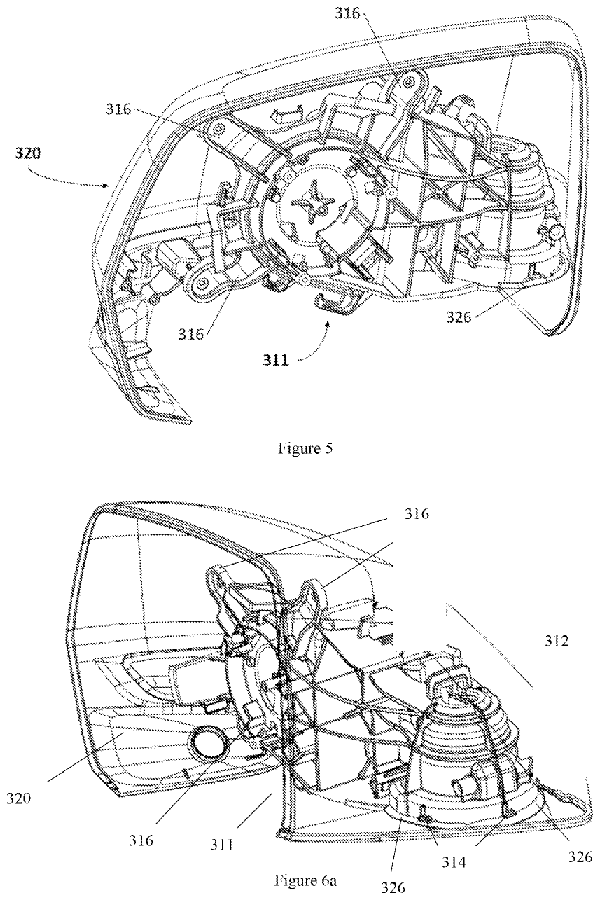

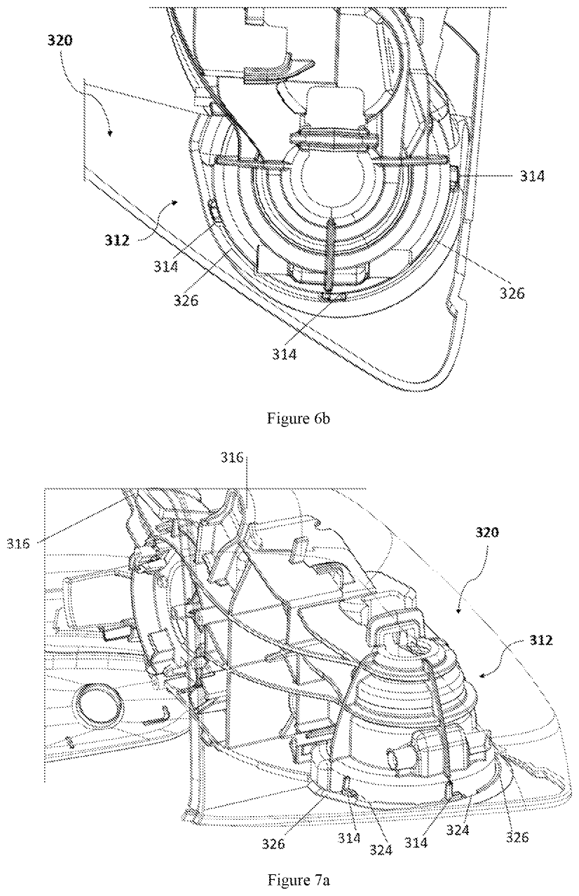

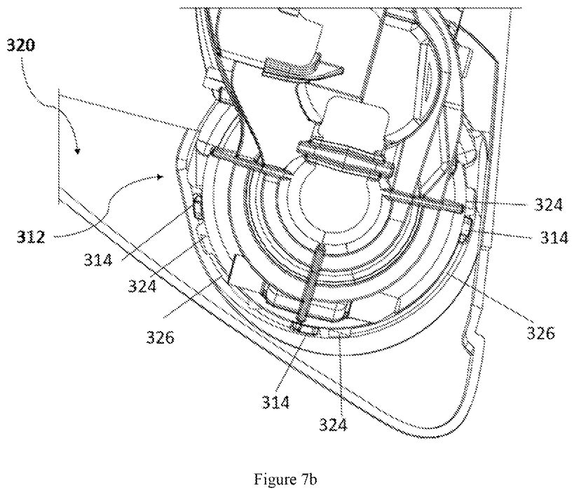

FIG. 5 illustrates an isometric view of an assembly of the upper mirror housing and of the mirror case frame. Further, FIGS. 6a-6b illustrate isometric views of the assembly of the upper mirror housing and of the mirror case frame in an unlocked state, and FIGS. 7a-7b illustrate isometric views of the assembly of the upper mirror housing and of the mirror case frame in a locked state. The mirror case fame 310 is secured with the upper mirror housing 320 using a twist-lock mechanism in combination with a fastening mechanism. The second mirror case frame end 312 and the second upper mirror housing end 322 are coupled together using the twist-lock mechanism. Further, the first mirror case frame end 310 and the first upper mirror housing end 321 are coupled using a fastening mechanism, wherein the twist-lock mechanism facilitates the fastening mechanism. As illustrated in FIGS. 6a and 6b, the mirror case frame 310 is inserted from the bottom of the upper mirror housing 320 to an upwards direction. Due to the matching configuration of the second case frame end 312 and the upper mirror housing end 322, the second mirror case frame end 312 pass through the opening 314 of the upper mirror housing 320 and the movement is further restricted by the case the end-stop wall 315. In this unlocked state, the first mirror case frame end 311 and the upper mirror housing end 322 are not in proximity with each other, and therefore fastening mechanism can not be performed. However, as illustrated in FIGS. 7a and 7b, after performing the twist-lock mechanism, the first mirror case frame end 311 and the upper mirror housing end 322 are in proximity with each other, and thus a second operation i.e. the fastening mechanism can be performed to secure the fitment of the mirror case frame 310 and the upper mirror housing.

The opening 323 of the upper mirror housing 320 is further configured with at least one cut-out 324, and the opening 323 is configured to allow the mirror case frame 310 to enter, vertically with respect to the length of the upper mirror housing 320 along the axis X-X, from the bottom in an upward direction such that at least one rib 314 of the mirror case frame 310 passes through the at least one cut-out 324 of the upper mirror housing 320. The twist-lock mechanism involves twisting the mirror case frame 310 with respect to the upper mirror housing 320. Further, the twist-lock mechanism involves sliding the at least one extended rib 314 of the mirror case frame 310 on a sliding plane 326 of the end-stop wall 315 of the second upper mirror housing 320 such that to restrict a downward movement. The restriction of movement of the mirror case frame 310 in the upward direction and in the downward direction is simultaneously achieved by the offset positioning of the at least one end-stop wall 315 and the at least one rib 314, therefore, any further upward or downward movement of the mirror case frame 310 is restricted.

After the twist-lock mechanism is performed, and now that the at least one fastening coupler 325 of the first upper mirror housing end and the at least one extended arm 316 of the first case frame end are in proximity with respect to each other, the fastening mechanism is performed to secure the assembly. The at least one extended arm 316 and the at least one fastening coupler 325 is secured using at least one fastening mechanism including a screwing mechanism, a snap-fit mechanism or using adhesive. After the fastening mechanism is performed, the twist-lock mechanism is furthermore secured, thereby restricting any twist operation which may unlock the twist-lock fitment of the assembly.

Further, a method of assembling the exterior rear-view mirror assembly 100 is disclosed. The assembling process of the exterior rear-view mirror assembly 100 comprising steps of: attaching a mirror base 200 to the vehicle 50, pivotably attaching a mirror head 300 to the mirror base 200. The mirror head 300 is configured to operate in a plurality of positions with respect to the mirror base 200, the mirror head 300 comprises a mirror case frame 310 for mounting a mirror glass 360 and an upper mirror housing 320 for securing the mirror case frame 310 and the mirror glass 360. Further, the steps comprising securing the mirror case fame 310 with the upper mirror housing 320 using a twist-lock mechanism in combination with a fastening mechanism, coupling the second mirror case frame end 312 and the second upper mirror housing end 322 using the twist-lock mechanism, and coupling the first mirror case frame 310 and the first upper mirror housing end 321 using a fastening mechanism. The twist-lock mechanism enables the fastening mechanism, the upper mirror housing has a first upper mirror housing end 321 and a second upper mirror housing end 322, and the mirror case frame 310 has a first mirror case frame end 311 and a second mirror case frame end 312.

Further, the steps of performing the twist-lock function between the mirror case frame 310 and the upper mirror housing 320 involves engaging the mirror case frame 310 towards the opening 323 of the upper mirror housing 320, vertically with respect to the length of the upper mirror housing 320, from the bottom in an upward direction such that at least one rib 314 of the mirror case frame 310 passes through the at least one cut-out 324 of the upper mirror housing 320.

Furthermore, the steps of performing the fastening mechanism involves securing the at least one extended arm 316 and the at least one fastening coupler 325 using at least one fastening mechanism including a screwing mechanism, a snap-fit mechanism or using adhesive, and performing the fastening mechanism in an event the twist-lock mechanism brings the at least one extended arm 316 and the at least one fastening coupler 325 in proximity.

Further, the present disclosure advantageously encompasses an exterior rear-view mirror assembly 100 that allows a technical advantage of multi-stage fixation of the mirror case frame 310 and the upper mirror housing 320, including a first twist-lock mechanism that safely holds and locks the mirror case frame 310 with the mirror housing 320 at one end while the other end is reduced to a close proximity between the mirror case frame 310 and the mirror housing 320 and is latched using a fastening mechanism such that the twist-lock mechanism can only be unlocked when un-fastened from the other end, thereby reducing the additional latching requirements, complexity of the assembly process and time.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims, i.e. the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

### REFERENCE SIGNS

50 Vehicle
100 Exterior rear-view mirror assembly
200 Mirror base
300 Mirror head
310 Mirror case frame
311 First mirror case frame end
312 Second mirror case frame end
313 Mirror case frame profile
314 Extended rib(s)
315 End-stop wall(s)
316 Extended arm(s)
320 Upper mirror housing
321 First upper mirror housing end
322 Second upper mirror housing end
323 Opening
324 Cut-out(s)
325 Fastening coupler(s)
326 Sliding plane
330 Glass actuator
340 Lower mirror housing
350 Bezel
360 Mirror glass
X-X Axis along the length of the upper mirror housing end

It is claimed:

1. An exterior rear-view mirror assembly for a vehicle, comprising
a mirror base attached to the vehicle; and
a mirror head pivotably attached to the mirror base, wherein the mirror head is configured to operate in a plurality of positions with respect to the mirror base,
the mirror head comprising a mirror case frame operably coupled to a glass actuator for mounting a mirror glass and an upper mirror housing for securing the mirror case frame and the mirror glass,
wherein the upper mirror housing has a first upper mirror housing end and a second upper mirror housing end,
wherein the mirror case frame has a first mirror case frame end and a second mirror case frame end, and
wherein the mirror case fame is secured with the upper mirror housing using a twist-lock mechanism in combination with a fastening mechanism, wherein the second mirror case frame end and the second upper mirror housing end are coupled using the twist-lock mechanism, and the first mirror case frame end and the first upper mirror housing end are coupled using a fastening mechanism, wherein the twist-lock mechanism enables the fastening mechanism.

2. The exterior rear-view mirror assembly according to claim 1, further comprising a lower mirror housing coupled to form an enclosure such that to accommodate the mirror case frame, the glass actuator and the mirror glass.

3. The exterior rear-view mirror assembly according to claim 1, further comprises a bezel secured with the assembly of mirror housings wherein the bezel is placed between the glass actuator and the mirror glass.

4. The exterior rear-view mirror assembly according to claim 1, wherein the mirror case frame is operably coupled with the glass actuator to enable movement of the mirror glass.

5. The exterior rear-view mirror assembly according to claim 1, wherein the mirror case frame is configured to accommodate at least one actuator for changing the position of the mirror head with respect to the mirror base to one of the plurality of positions.

6. The exterior rear-view mirror assembly according to claim 1, wherein the mirror glass is operably secured with the mirror case frame via the glass actuator such that a pre-configured angle of the mirror glass can be changed with respect to the mirror case frame.

7. The exterior rear-view mirror assembly according to claim 1, wherein the second mirror case frame end is configured to accommodate at least one actuator in a direction perpendicular to an axis extending from the first upper mirror housing end to the second upper mirror housing end of the mirror case frame.

8. The exterior rear-view mirror assembly according to claim 1, wherein the second mirror case frame end of the mirror case frame is configured with a mirror case frame profile, having at least one extended rib and at least one end-stop wall, offset to each other.

9. The exterior rear-view mirror assembly according to claim 8, wherein the at least one end-stop wall restricts further movement of the mirror case frame in the upward direction.

10. The exterior rear-view mirror assembly according to claim 1, wherein the second upper mirror housing end is configured with an opening towards a bottom end of the upper mirror housing.

11. The exterior rear-view mirror assembly according to claim 10, wherein the opening is configured to match the mirror case frame profile.

12. The exterior rear-view mirror assembly according to claim 8, wherein
the opening is further configured with at least one cut-out, and
the opening is configured to allow the mirror case frame to enter, vertically with respect to the length of the upper mirror housing, from the bottom in an upward direction such that at least one rib of the mirror case frame passes through the at least one cut-out of the upper mirror housing.

13. The exterior rear-view mirror assembly according to claim 1, wherein the twist-lock mechanism involves twisting the mirror case frame with respect to the upper mirror housing.

14. The exterior rear-view mirror assembly according to claim 1, wherein the twist-lock mechanism involves sliding the at least one extended rib of the mirror case frame on a sliding plane of the end-stop wall of the second upper mirror housing such that to restrict a downward movement.

15. The exterior rear-view mirror assembly according to claim 9, wherein the restriction of movement of the mirror case frame in the upward direction and in the downward direction is simultaneously achieved by the offset positioning of the at least one end-stop wall and the at least one rib.

16. The exterior rear-view mirror assembly according to claim 1, wherein the first mirror case frame end is configured with at least one extended arm.

17. The exterior rear-view mirror assembly according to claim 1, wherein the upper mirror housing is configured with at least one fastening coupler.

18. The exterior rear-view mirror assembly according to claim 16, wherein the at least one extended arm is in proximity with the at least one fastening coupler after the twist-lock mechanism is performed between the mirror case frame and the upper mirror housing.

19. The exterior rear-view mirror assembly according to claim 16, wherein the at least one extended arm and the at least one fastening coupler is secured using at least one fastening mechanism including a screwing mechanism, a snap-fit mechanism or using adhesive.

20. A vehicle comprising the exterior rear-view assembly according to claim 1.

21. A method of assembling the exterior rear-view mirror assembly, comprising:
attaching a mirror base to the vehicle;
pivotably attaching a mirror head to the mirror base, wherein the mirror head is configured to operate in a plurality of positions with respect to the mirror base, and wherein the mirror head includes a mirror case frame for mounting a mirror glass and an upper mirror housing for securing the mirror case frame and the mirror glass;
securing the mirror case frame with the upper mirror housing using a twist-lock mechanism in combination with a fastening mechanism, coupling a second mirror case frame end and a second upper mirror housing end using the twist-lock mechanism; and
coupling a first mirror case frame and a first upper mirror housing end using a fastening mechanism, wherein
the twist-lock mechanism enables the fastening mechanism, the upper mirror housing has a first upper mirror housing end and a second upper mirror housing end, and the mirror case frame has a first mirror case frame end and a second mirror case frame end.

22. The method of assembling the exterior rear-view mirror assembly according to claim 21, further comprising
engaging the mirror case frame towards the opening of the upper mirror housing, vertically with respect to the length of the upper mirror housing, from the bottom in an upward direction such that at least one rib of the mirror case frame passes through the at least one cut-out of the upper mirror housing.

23. The method of assembling the exterior rear-view mirror assembly according to claim 21, further comprising twisting the mirror case frame with respect to the upper mirror housing to perform the twist-lock mechanism.

24. The method of assembling the exterior rear-view mirror assembly according to claim 21, further comprising
securing the at least one extended arm and the at least one fastening coupler using at least one fastening mechanism including a screwing mechanism, a snap-fit mechanism or using adhesive, and
performing the fastening mechanism in an event the twist-lock mechanism brings the at least one extended arm and the at least one fastening coupler in proximity.
